(19) United States
(12) Patent Application Publication
(10) Pub. No.: US 2014/0201768 A1
(43) Pub. Date: Jul. 17, 2014

(54) SYSTEM AND METHOD FOR RECORDING AND ANALYZING AUDIENCE INFORMATION OF AUDIO/VIDEO PROGRAM

(71) Applicant: Industrial Technology Research Institute, Hsinchu (TW)

(72) Inventors: Tun-Hao You, New Taipei City (TW); Cheng-Liang Lin, Kaohsiung City (TW); Jin-Chin Chung, Taipei City (TW)

(73) Assignee: Industrial Technology Research Institute, Hsinchu (TW)

(21) Appl. No.: 13/956,379

(22) Filed: Aug. 1, 2013

(30) Foreign Application Priority Data
Jan. 17, 2013 (TW) 102101818

(51) Int. Cl. H04N 21/442

(52) U.S. Cl. CPC H04N 21/44222
USPC 725/14

(57) ABSTRACT

A method for recording and analyzing audience information of an audio/video program is provided. The method includes receiving at least one user information from at least one online social service, at least one audio/video capture information from at least one terminal device associated with the at least one user information, and at least one social behavior information related to the at least one audio/video capture information from the at least one online social service. The method includes establishing a relationship between the at least one user information, the at least one audio/video capture information, and the at least one social behavior information, and recording the relationship and the foregoing information into an audience information database. The method includes when receiving a querying command, generating a querying result of qualitative rating according to at least one reference information acquired from the audience information database in accordance with the querying command.

### CROSS-REFERENCE TO RELATED APPLICATION

This application claims the priority benefit of Taiwan application serial no. 102101818, filed on Jan. 17, 2013. The entirety of the above-mentioned patent application is hereby incorporated by reference herein and made a part of this specification.

### TECHNICAL FIELD

The technical field relates to a system and a method for immediately recording and analyzing audience information of an audio/video program, a querying system of qualitative rating, and an audio/video program viewing system.

### RELATED ART

The rapid growth in the television media industry has generated considerable economic effects. Audience measurement is a mechanism to determine an approximate weighting of an audience for a program during a certain timeslot against the entire population. Using this information, related businesses can benefit by putting out corresponding advertisements. Audience measurement has been developed in the United States for many years. Generally speaking, the audience behaviors of all the viewers are restricted to the sampled audience by using telephone surveys or installing people meters. The obtained information includes the program channel viewed and the amount of program viewing time, for example. The audience rating is then compiled by sampling in fixed time periods, although this method can only obtain the audience rating of a channel during the sampling time. The audience measurement companies in the United States are categorized by several different types of surveys used. The AC Nielsen Company uses the installed people meters to survey the household audience. On the other hand, the XKM International Corp. measures the audience by using randomly sampled telephone interviews of different levels. However, current audience measurement methods are inadequate and prone to inaccurate survey results.

For example, conventional audience measurement methods should be agreed to by the households, which lead to inadequate systematic representation in the sampling. Moreover, the designs of the measurement methods are not adapted to the viewer. As an example, for the people meters installed to survey the household audience, the people meters merely determine that the television is turned on and stopped at a certain channel, but cannot effectively determine the amount of viewers watching the television. Furthermore, people meters cannot determine whether the viewer is in front of a TV or not. However, an accurate method to obtain audience rating is needed. On the other hand, telephone interviews are resource intensive, and the results cannot be obtained efficiently.

### SUMMARY

The disclosure provides a system and a method for immediately recording and analyzing audience information of an audio/video program, a querying system of qualitative rating, and an audio/video program viewing system. The audience information includes user information from an online social service, an audio/video capture information from a terminal device associated with the user information, and a social behavior information on the online social service related to the audio/video capture information from the online social service. For instance, when a user views a program and voluntarily shares a related audio/video clip to an online social service, the qualitative rating is determined in accordance with the various types of sharing activities of the audio/video clip on the online social service, so as to generate qualitative rating information of preferable reference value.

The disclosure provides a system for immediately recording and analyzing audience information of an audio/video program, including a network unit, a storage unit, and a processing unit. The network unit is used to access a network, and the storage unit contains a database that is used for storing audience information. The processing unit couples to the network unit and the storage unit. The processing unit receives, through the network unit, at least one user information from at least one online social service, at least one audio/video capture information from at least one terminal device associated with the at least one user information, and at least one social behavior information related to the at least one audio/video capture information from the at least one online social service. The processing unit establishes a relationship between the at least one user information, the at least one audio/video capture information, and the at least one social behavior information, and records the relationship and the at least one user information, the at least one audio/video capture information, and the at least one social behavior information into the audience information database. When the processing unit receives a querying command through the network unit, the processing unit selects at least one reference information acquired from the audience information database in accordance with the querying command, so as to generate a querying result of qualitative rating.

From another perspective, the disclosure provides a querying system of qualitative rating, including a network unit and a processing unit coupled to each other. The network unit is for accessing a network. When the processing unit receives a querying command through the network unit, the processing unit connects to an audience information database to obtain at least one reference information matching the querying command, and a querying result of qualitative rating is generated by statistically analyzing the at least one reference information. The querying command includes one of a time slot, a viewer age group, a viewer sex, and a program name, or a combination thereof.

From another perspective, the disclosure provides an audio/video program viewing system, including a terminal device, an audio/video capturing server, an information recording server, and a qualitative rating analysis server. The audio/video capturing server is for capturing an audio/video capture information from a currently broadcasted program according to a capture command from the terminal device, and transmitting the audio/video capture information to the terminal device, so the terminal device uploads the audio/video capture information to an online social service. The information recording server is for establishing an audience information database to record the audio/video capture information from the terminal device, a user information from the online social service, and a social behavior information related to the audio/video capture information. The qualitative rating analysis server is for requesting the information recording server according to a querying command to transmit at least one reference information matching the querying command, when the querying command is received, and generating a querying result of qualitative rating by statistically analyzing the at least one reference information. The querying command includes one of a time slot, a viewer age group, a viewer sex, and a program name, or a combination thereof.

From another perspective, the disclosure provides a method for immediately recording and analyzing audience information of an audio/video program. The method includes receiving at least one user information from at least one online social service, at least one audio/video capture information from at least one terminal device associated with the at least one user information, and at least one social behavior information related to the at least one audio/video capture information from the at least one online social service. A relationship is established between the at least one user information, the at least one audio/video capture information, and the at least one social behavior information. Moreover, the relationship and the at least one user information, the at least one audio/video capture information, and the at least one social behavior information are recorded into an audience information database. When a querying command is received, at least one reference information is selected from the audience information database in accordance with the querying command, so as to generate a querying result of qualitative rating.

In summary, embodiments of the disclosure are based upon the audio/video data voluntarily captured by the user and uploaded to the online social service when viewing a program. The state of the audio/video data being viewed, shared, and commented by others on the online social service is used to determine the qualitative rating. Accordingly, querying results of qualitative rating having preferable accuracy and reference value could be generated.

Several exemplary embodiments accompanied with figures are described in detail below to further describe the disclosure in details.

### BRIEF DESCRIPTION OF THE DRAWINGS

The accompanying drawings constituting a part of this specification are incorporated herein to provide a further understanding of the disclosure. Here, the drawings illustrate embodiments of the disclosure and, together with the description, serve to explain the principles of the disclosure.

FIG. 1 is a schematic view of a usage environment of a system for immediately recording and analyzing audience information of an audio/video program according to an exemplary embodiment of the disclosure.

FIG. 2 is a block diagram of a system for immediately recording and analyzing audience information of an audio/video program according to an exemplary embodiment of the disclosure.

FIG. 3 is a flow diagram of a method for immediately recording and analyzing audience information of audio/video program according to an exemplary embodiment of the disclosure.

FIG. 4A is a block diagram of a querying system of qualitative rating according to an exemplary embodiment of the disclosure.

FIG. 4B is a curve diagram of a usage frequency of an audio/video data on an online social service according to an exemplary embodiment of the disclosure.

FIG. 5 is a block diagram of an audio/video program viewing system according to an exemplary embodiment of the disclosure.

FIG. 6 is a flow diagram of capturing an audio/video capture information according to an exemplary embodiment of the disclosure.

FIG. 7 is a flow diagram of obtaining a social behavior information according to an exemplary embodiment of the disclosure.

### DESCRIPTION OF EMBODIMENTS

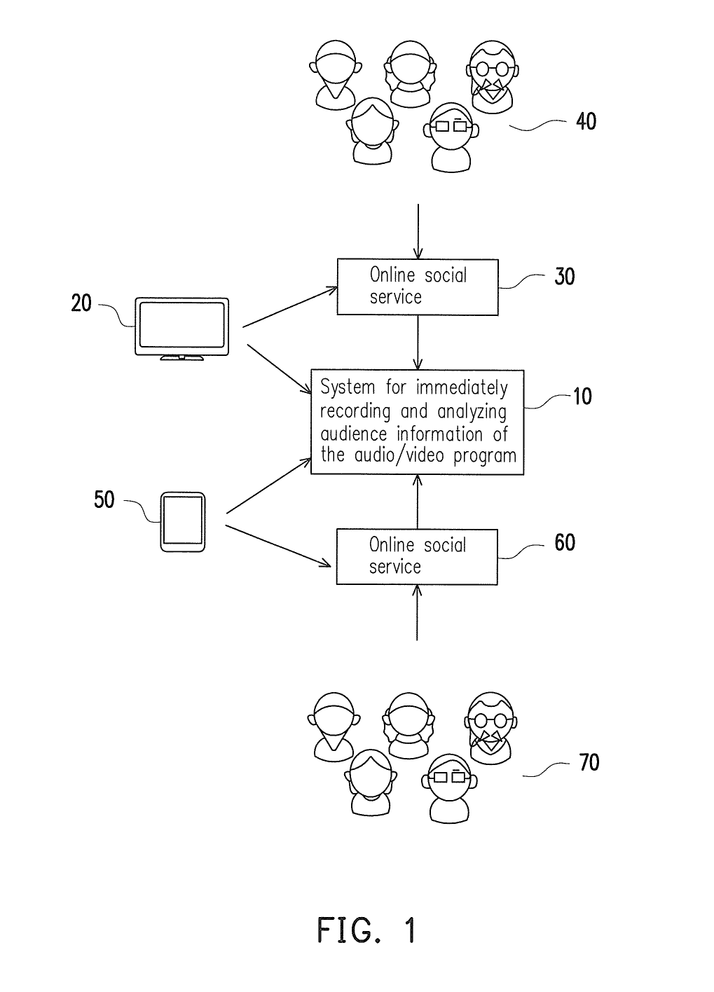

FIG. 1 is a schematic view of a usage environment of a system for immediately recording and analyzing audience information of an audio/video program according to an exemplary embodiment of the disclosure. With reference to FIG. 1, in the present embodiment, when a user is watching an audio/video program and becomes interested in the broadcasted content, the audio/video data clip that the user is interested in could be obtained through a terminal device (e.g. terminal devices 20 and 50). When this audio/video data clip is uploaded to an online social service (e.g. online social services 30 and 60), the related audio/video capture information is also uploaded to a system 10 for immediately recording and analyzing audience information of the audio/video program. Thereafter, when the friends 40 and 70 on the online social services 30 and 60 perform social behaviors such as sharing, viewing, or commenting this audio/video data clip, a related social behavior information is transmitted to the system 10 for immediately recording and analyzing audience information of the audio/video program. Accordingly, the system 10 for immediately recording and analyzing audience information of the audio/video program could determine the ranking of the qualitative rating of the program according to the information from the terminal devices and the various types of online social services. Moreover, the program clips and frames viewed by particular age groups or particular demographics could be analyzed.

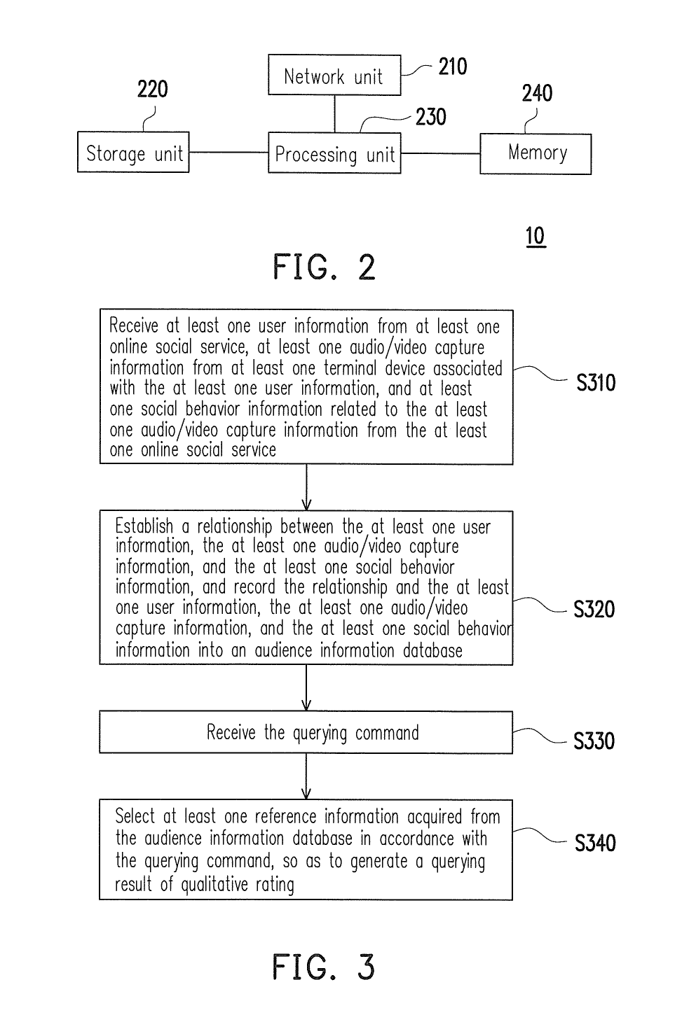

FIG. 2 is used hereafter to describe the elements in the system 10 for immediately recording and analyzing audience information of the audio/video program. As shown in FIG. 2, the system 10 for immediately recording and analyzing audience information of the audio/video program includes a network unit 210, a storage unit 220, and a processing unit 230.

The network unit 210 could access a network so the system 10 for immediately recording and analyzing audience information of the audio/video program could transmit data and communicate with other devices. In the present embodiment, the network unit 210 could be connected to a wired network and/or a wireless network. The wired network includes the Internet, a Local Area Network (LAN), or a Wide Area Network (WAN), for example. The wireless network includes a Wireless Fidelity (WiFi) network, a Global System for Mobile Communication (GSM) network, a Code Division Multiple Access (CDMA) network, a General Packet Radio Service (GPRS) network, a 3rd-Generation (3G) network, a 4G network, or a Worldwide Interoperability for Microwave Access (WiMAX) network, for example.

The storage unit 220 contains a database that is used for storing an audience information. For example, the storage unit 220 may be a hard disk drive (HDD), a solid-state drive (SSD), or any non-volatile storage device, and the type is not limited thereto.

The processing unit 230 is coupled to the network unit 210 and the storage unit 220. The processing unit 230 may be a central processing unit (CPU) for controlling and coordinating the overall operation of the system 10 for immediately recording and analyzing audience information of the audio/video program. The processing unit 230 is further for generating a qualitative rating information having high accuracy and reference value according to a method for immediately recording and analyzing audience information of the audio/video program of the present embodiment. The method for immediately recording and analyzing audience information of the audio/video program of the present embodiment will be described later with reference to the drawings.

In another embodiment, the system 10 for immediately recording and analyzing audience information of the audio/video program further includes a memory 240, such as a Static Random Access Memory (SRAM), or a Dynamic Random Access Memory (DRAM). The memory 240 is for registering the commands and data needed by the processing unit 230, and registering the calculation results generated by the processing unit 230.

In order to further describe the detailed operation of the system 10 for immediately recording and analyzing audience information of the audio/video program, another embodiment is illustrated below. FIG. 3 is a flow diagram of a method for immediately recording and analyzing audience information of audio/video program according to an exemplary embodiment of the disclosure. Please refer to both FIGS. 2 and 3.

As shown in Step S310, the processing unit 230 receives, through the network unit 210, at least one user information from at least one online social service, at least one audio/video capture information from at least one terminal device associated with the user information, and at least one social behavior information related to the audio/video capture information from the at least one online social service.

For example, when a user connects to a server providing an online social service through a terminal device, the user could use the online social service on the terminal device after entering an authenticated account and password. Thereafter, while the user watches a program broadcasted by a cable television broadcast system, a wireless television broadcast system, or a network television broadcast system, if the user sees an interested content, the user could capture an audio/video data from the program being broadcasted through the terminal device. The audio/video data may be a video clip, a photo, or a sound, and the type is not limited thereto.

If the user wishes to share the audio/video data with others and uploads it to the online social service, a capture time information and a program information related to the audio/video data are also transmitted to the system 10 for immediately recording and analyzing audience information of the audio/video program. For example, the capture time information includes time stamps related to the audio/video data, such as the time stamps respectively corresponding to a starting point and an ending point of the audio/video data. The time stamps may correspond to absolute time or relative time. The absolute time may match a system time of the system 10 for immediately recording and analyzing audience information of the audio/video program, and the relative time may be relative to a start time of the broadcasted program. The program information includes at least one of a channel information, a program name information, a program participant information, a program type, and a metadata, or a combination thereof. The metadata may be provided by the program producers, or automatically generated by the user through a particular platform. For a food program, the metadata may be a detailed recipe of a dish, as an example. For a music program, the metadata may be the tracks broadcasted by the program. In order to facilitate description, the disclosure hereafter refers to the related audio/video data, capture time information, and program information together as an audio/video capture information.

It should be noted that, when the user shares the audio/video data to the online social service, the user information related to the online social service is also transmitted to the system 10 for immediately recording and analyzing audience information of the audio/video program. The user information may include one of a user age, a user sex, a user place of residence, and a friend information based in the online social service, or a combination thereof, although the disclosure is not limited thereto.

Once the audio/video data is uploaded to the online social service, other users of the online social service may exploit the audio/video data such as sharing/linking, viewing, or commenting. If the audio/video data is used by other users on the online social service, then a related usage condition is transmitted to the system 10 for immediately recording and analyzing audience information of the audio/video program. For example, the usage condition includes one of a share/link frequency, a view frequency, a comment frequency, and a comment content, or a combination thereof, although the disclosure is not limited thereto. Furthermore, the user information of users exploiting the audio/video data is also transmitted to the system 10 for immediately recording and analyzing audience information of the audio/video program.

It should be noted that, the system 10 for immediately recording and analyzing audience information of the audio/video program could receive information from a plurality of different terminal devices and different online social services. For each the foregoing information received by the processing unit 230, as shown in Step S320, a relationship is established between the user information, the audio/video capture information, and the social behavior information. Moreover, the relationship of the user information, the audio/video capture information, and the social behavior information is recorded into the audience information database of the storage unit 220. In other words, the processing unit 230 records in the audience information database the audio/video capture information corresponding to each user information, and records the social behavior information corresponding to each audio/video capture information. By using the relationship between the information, operations such as look-up and analysis could be rapidly performed.

In Step S330, the processing unit 230 receives a querying command through the network unit 210. The querying command may be transmitted by a third party such as an advertiser, a film studio, a program producing unit, or a product manufacturer. The querying command may include one or a plurality of querying conditions such as a time slot, a viewer age group, a viewer sex, and a program name. However, the querying conditions are exemplary to facilitate description, and the disclosure is not limited thereto. In other words, any conditions of the querying result calculated from the information recorded by the audience information database are within the scope of the disclosure.

In Step S340, the processing unit 230 selects one or a plurality of reference information acquired from the audience information database in accordance with the querying command, so as to generate a querying result of qualitative rating. For example, the processing unit selects all of the reference information from the audience information database matching the querying command, so as to analyze the reference information and generate the querying result of qualitative rating. The processing unit could adopt any algorithm, equation, or mechanism in data statistics to process the reference information in order to obtain the querying result of qualitative rating, and the disclosure is not limited thereto.

According to the foregoing embodiments, the system 10 for immediately recording and analyzing audience information of the audio/video program could not only immediately record the audience information generated by the user viewing the audio/video program, but also use the voluntarily captured audio/video data by the user due to interest, as well as the usage state of the audio/video data by other users on the online social service as the criteria for judging the qualitative rating. Therefore, a querying result of qualitative rating accurately reflecting the audience preference could be obtained. The advertiser, film studio, program producing unit, or the product manufacturer could accordingly obtain a qualitative rating information that has preferable reference value.

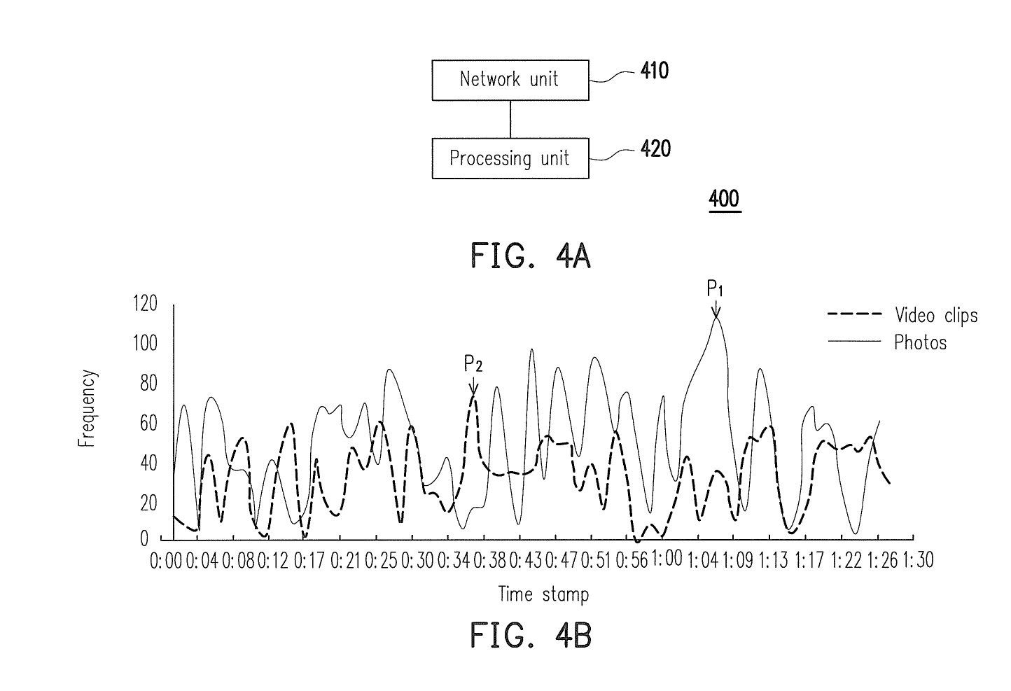

FIG. 4A is a block diagram of a querying system of qualitative rating according to an exemplary embodiment of the disclosure. With reference to FIG. 4A, a querying system 400 of qualitative rating includes a network unit 410 and a processing unit 420 coupled to each other. The network unit 410 is for accessing a wired and/or wireless network. The processing unit 420 may be a central processing unit for accessing the information recording in the audience information database. In the present embodiment, the audience information database may be stored in a server (e.g. cloud storage server) independent from the querying system 400 of qualitative rating, which could be managed and maintained by a particular service provider. The querying system 400 of qualitative rating may mainly access the content of the audience information database through the network, for example.

In the present embodiment, the querying system 400 of qualitative rating may provide a querying interface to receive the query command from the third party. In specifics, when the processing unit 420 receives the querying command through the network unit 410, the network unit 410 is used to connect to the audience information database, so as to obtain one or a plurality of reference information in the database matching the querying command. Moreover, the querying result of qualitative rating is generated from statistically analyzing the reference information. The querying command includes one of a time slot, a viewer age group, a viewer sex, and a program name, or a combination thereof.

For example, when an advertiser seeks to determine which program a certain age group follows a produced advertisement at a highest level, the querying system 400 of qualitative rating could be connected through the network, and a querying command including the querying condition of the viewer age group could be entered. After the processing unit 420 receives the querying command, the audience information database is connected to query each of the user information recorded. Moreover, the audio/video capture information associated with the user information matching the viewer age group indicated in the query command is selected. From all of the audio/video capture information selected, the audio/video data including the advertisement produced by the advertiser is determined. The analysis result could then be obtained by in accordance with the frequency of shares/links, views, and comments of the audio/video data by the friends in the online social service.

In another embodiment, when the program producing unit seeks to determine whether a program clip followed by viewers and friends has met the expectations of the production crew, the querying system 400 of qualitative rating could be connected through the network, and a querying command including the querying condition of the program name could be entered. After the processing unit 420 receives the querying command, the audience information database is connected to obtain all of the audio/video capture information related to the program. Moreover, the social behavior information corresponding to each audio/video capture information is referenced to compile the frequency of times each of the audio/video capture information including the audio/video data has been used (e.g., the frequency of shares/links, views, and comments). In specifics, after the processing unit 420 compiles a usage frequency of various types of audio/video data captured from the program, a filter could be utilized to find the clips used the most, and the filtered clip is the content the audience follows substantially more.

FIG. 4B is a curve diagram of a usage frequency of an audio/video data on an online social service according to an exemplary embodiment of the disclosure. With reference to FIG. 4B, the two curves respectively represents the relationships of usage frequencies and time of the video clips and photos captured from a program on an online social service. For photos, a curve peak P1 falls between the time stamps 1:04 to 1:09, which represents the images shown by the program during this time period is followed more by the audience. For video clips, the popular and followed content could also be determined according to the time stamp where a curve peak P2 is located.

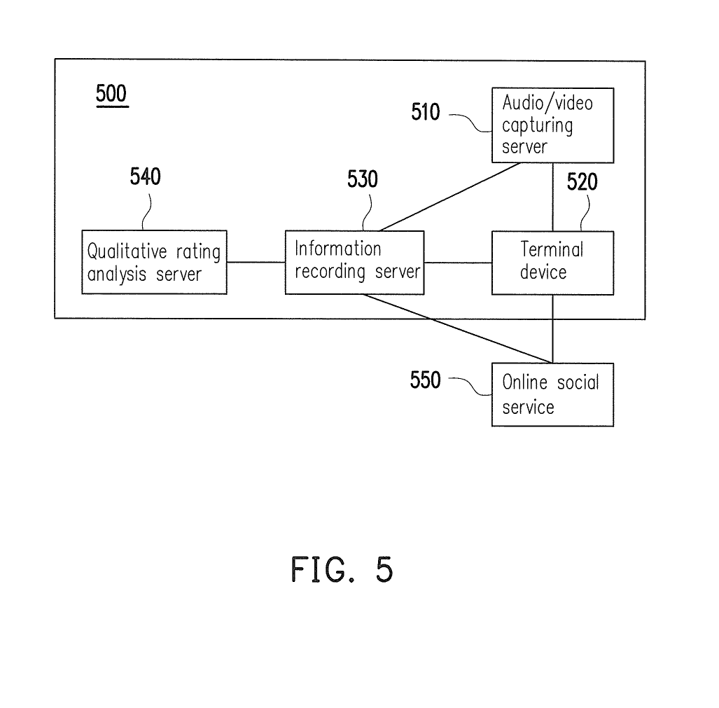

In another aspect, the disclosure provides an audio/video program viewing system. With reference to FIG. 5, an audio/video program viewing system 500 includes an audio/video capturing system 510, a terminal device 520, an information recording server 530, and a qualitative rating analysis server 540. The audio/video capturing system 510, the information recording server 530, and the qualitative rating analysis server 540 may be implemented in a same or different server hosts, and the disclosure is not limited thereto.

According to a capture command from the terminal device 520, the audio/video capturing server 510 captures an audio/video capture information from a currently broadcasted program, and transmits the audio/video capture information to the terminal device 520. The terminal device 520 uploads the audio/video capture information to an online social service 550. The audio/video capturing server 510 may also directly transmit the audio/video capture information to the information recording server 530. The terminal service 520 may be a cell phone, a web-enabled television, a smart TV, a tablet computer, a remote controller, a personal computer, or any electronic device having a processor and a display, and the disclosure is not limited thereto. The audio/video capturing server 510 could capture and edit the programs broadcasted by an arbitrary channel according to the capture command. In specifics, the audio/video capturing server 510 may be a cloud audio/video editing system capturing a video clip of a particular length, a photo, or a sound according to a particular time and a particular channel. It should be noted that, in order to provide sufficient time for user operation, even if a time point corresponding to the capture command is T, the audio/video capturing server 510 could still use as a time point earlier than the time point T as a starting time point for capturing the audio/video data.

The information recording server 530 is for maintaining the audience information database to record the audio/video capture information from the terminal device 520 or the audio/video capturing server 510, as well as the user information from the online social service 550 and the social behavior information related to the audio/video capture information. The contents of the user information, audio/video capture information, and the social behavior information are similar or the same as in the earlier embodiments, and therefore further elaboration thereof is omitted hereafter.

The qualitative rating analysis server 540 is for requesting the information recording server 530 according to the querying command to transmit at least one reference information matching the querying command, when the querying command is received from the third party. The querying result of qualitative rating is generated by statistically analyzing the reference information, in which the querying command includes one of a time slot, a viewer age group, a viewer sex, and a program name, or a combination thereof. In one embodiment, the qualitative rating analysis server 540 may be located in a television station or an advertiser, and various information recorded by the information recording server 530 may be obtained with payment during a query.

The process flows of capturing the audio/video capture information and obtaining the social behavior information are respectively described hereafter.

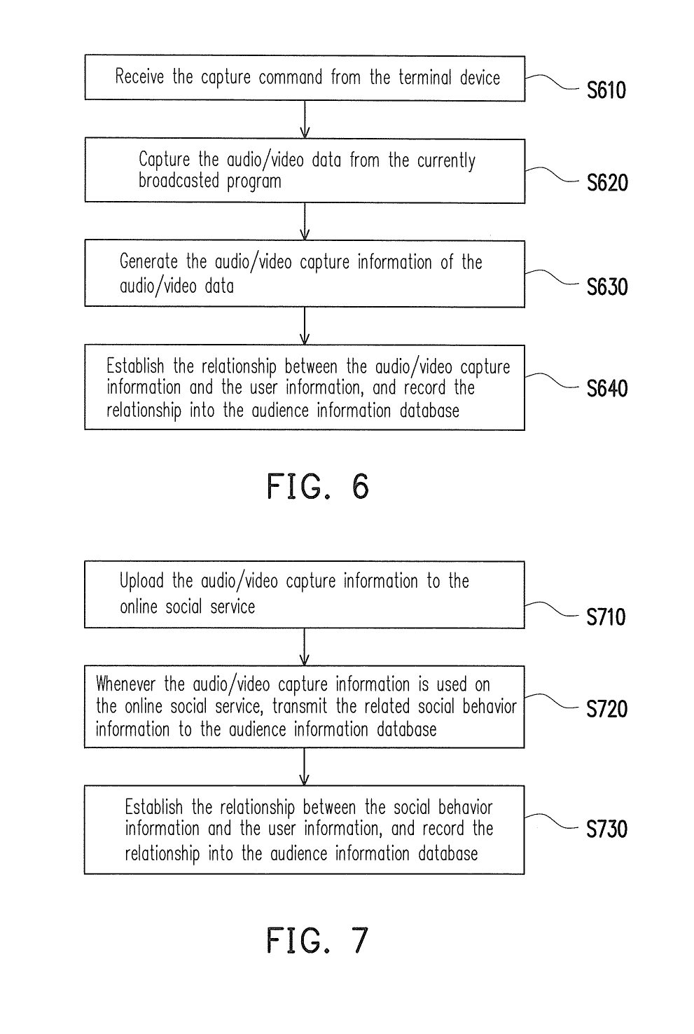

FIG. 6 is a flow diagram of capturing an audio/video capture information according to an exemplary embodiment of the disclosure. Please refer to FIGS. 5 and 6.

As shown in Step S610, the audio/video capturing server 510 receives the capture command from the terminal device 520. The capture command may include information such as channel, audio/video data type, and start/end time stamps.

In Step S620, the audio/video capturing server 510 captures the audio/video data from a currently broadcasted program according to the capture command. Moreover, in Step S630, the audio/video capture information corresponding to the audio/video data is generated. For example, the related program information is obtained, and the audio/video data, the program information, and the capture time information are combined into the audio/video capture information.

As shown in Step S640, the audio/video capture information is transmitted to the information recording server 530. The information recording server 530 establishes the relationship between the audio/video capture information and the user information, and records the relationship into the audience information database.

FIG. 7 is a flow diagram of obtaining a social behavior information according to an exemplary embodiment of the disclosure. Please refer to FIGS. 5 and 7.

In Step S710, the terminal device 520 uploads the audio/video capture information to the online social service 550 through the network.

As shown in Step S720, whenever the audio/video capture information is used on the online social service 550, the related social behavior information is transmitted to the audience information database maintained by the information recording server 530. As shown in Step S730, the information recording server 530 establishes the relationship between the social behavior information and the user information, and records the relationship and the information contents into the audience information database.

In view of the foregoing, according to embodiments of the disclosure, after the user views the audio/video program and voluntarily captures audio/video data and uploads to the online social service, the usage of the audio/video data by other users on the online social service such as sharing/linking, viewing, and commenting serve as the criteria for judging the qualitative rating of the program. Since the user voluntarily and actively uploads or further uses the audio/video data on the online social service, the qualitative rating obtained is preferably accurate and beneficial to use as reference by the advertiser, film studio, program producing unit, or the product manufacturer. Moreover, since the length of the audio/video data captured by the typical user is not long, program clips of higher popularity could be accurately determined, and thereby refined marketing operations could be generated. The disclosure could provide indicators representing the audience reactions of high accuracy and reference value, and these indicators are preferable for various subsequent adjustments by the third party.

It will be apparent to those skilled in the art that various modifications and variations could be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A system for immediately recording and analyzing audience information of an audio/video program, comprising:
a network unit for accessing a network;
a storage unit for storing an audience information database; and
a processing unit coupled to the network unit and the storage unit, wherein the processing unit receives, through the network unit, at least one user information from at least one online social service, at least one audio/video capture information from at least one terminal device associated with the at least one user information, and at least one social behavior information related to the at least one audio/video capture information from the at least one online social service,
the processing unit establishing a relationship between the at least one user information, the at least one audio/video capture information, and the at least one social behavior information, and recording the relationship and the at least one user information, the at least one audio/video capture information, and the at least one social behavior information into the audience information database,
when the processing unit receives a querying command through the network unit, the processing unit selects at least one reference information acquired from the audience information database in accordance with the querying command, so as to generate a querying result of qualitative rating.

2. The system of claim 1, wherein each of the at least one audio/video capture information comprises at least an audio/video data, a capture time info′ nation, and a program information.

3. The system of claim 2, wherein the audio/video data is captured from a program broadcasted by a cable television broadcast system, a wireless television broadcast system, or a network television broadcast system, and the audio/video data is a video clip, a photo, or a sound.

4. The system of claim 2, wherein the capture time information comprises time stamps related to capturing the audio/video data.

5. The system of claim 2, wherein the program information comprises at least one of a channel information, a program name information, a program participant information, a program type, and a metadata, or a combination thereof.

6. The system of claim 1, wherein each of the at least one user information comprises one of a user age, a user sex, a user place of residence, and a friend information based in the online social service, or a combination thereof.

7. The system of claim 1, wherein each of the at least one social behavior information comprises a usage condition of the related audio/video capture information on each of the at least one online social service, and the user information of users exploiting the related audio/video capture information on each of the at least one online social service.

8. The system of claim 7, wherein the usage condition comprises one of a share/link frequency, a view frequency, a comment frequency, and a comment content, or a combination thereof.

9. The system of claim 1, wherein the querying command comprises one of a time slot, a viewer age group, a viewer sex, and a program name, or a combination thereof, and the processing unit selects the at least one reference information from the audience information database matching the querying command, and the querying result of qualitative rating is generated by statistically analyzing the at least one reference information.

10. A querying system of qualitative rating, comprising:
a network unit for accessing a network; and
a processing unit coupled to the network unit, wherein when the processing unit receives a querying command through the network unit, the processing unit connects to an audience information database to obtain at least one reference information matching the querying command, and a querying result of qualitative rating is generated by statistically analyzing the at least one reference information, wherein the querying command comprises one of a time slot, a viewer age group, a viewer sex, and a program name, or a combination thereof.

11. The querying system of qualitative rating of claim 10, wherein the audience information database records at least one user information, at least one audio/video capture information, at least one social behavior information, and a relationship between the at least one user information, the at least one audio/video capture information, and the at least one social behavior information.

12. The querying system of qualitative rating of claim 11, wherein each of the at least one audio/video capture information comprises at least an audio/video data, a capture time information, and a program information.

13. The querying system of qualitative rating of claim 12, wherein the audio/video data is captured from a program broadcasted by a cable television broadcast system, a wireless television broadcast system, or a network television broadcast system, and the audio/video data is a video clip, a photo, or a sound.

14. The querying system of qualitative rating of claim 12, wherein the capture time information comprises time stamps related to capturing the audio/video data.

15. The querying system of qualitative rating of claim 12, wherein the program information comprises at least one of a channel information, a program name information, a program participant information, a program type, and a metadata, or a combination thereof.

16. The querying system of qualitative rating of claim 11, wherein each of the at least one user information comprises one of a user age, a user sex, a user place of residence, and a friend information based in the online social service, or a combination thereof.

17. The querying system of qualitative rating of claim 11, wherein each of the at least one social behavior information comprises a usage condition of the related audio/video capture information on each of the at least one online social service, and the user information of users exploiting the related audio/video capture information on each of the at least one online social service.

18. The querying system of qualitative rating of claim 17, wherein the usage condition comprises one of a share/link frequency, a view frequency, a comment frequency, and a comment content, or a combination thereof.

19. A audio/video program viewing system, comprising:
a terminal device;
an audio/video capturing server for capturing an audio/video capture information from a currently broadcasted program according to a capture command from the terminal device, and transmitting the audio/video capture information to the terminal device, so the terminal device uploads the audio/video capture information to an online social service;
an information recording server for establishing an audience information database to record the audio/video capture information from the terminal device, a user information and a social behavior information related to the audio/video capture information from the online social service; and
a qualitative rating analysis server for requesting the information recording server according to a querying command to transmit at least one reference information matching the querying command, when the querying command is received, and generating a querying result of qualitative rating by statistically analyzing the at least one reference information, wherein the querying command comprises one of a time slot, a viewer age group, a viewer sex, and a program name, or a combination thereof.

20. A method for immediately recording and analyzing audience information of an audio/video program, comprising:
receiving at least one user information from at least one online social service, at least one audio/video capture information from at least one ten Anal device associated with the at least one user information, and at least one social behavior information related to the at least one audio/video capture information from the at least one online social service;
establishing a relationship between the at least one user information, the at least one audio/video capture information, and the at least one social behavior information, and recording the relationship and the at least one user information, the at least one audio/video capture information, and the at least one social behavior information into an audience information database; and
when a querying command is received, selecting at least one reference information acquired from the audience information database in accordance with the querying command, so as to generate a querying result of qualitative rating.

21. The method of claim 20, wherein each of the at least one audio/video capture information comprises at least an audio/video data, a capture time information, and a program information.

22. The method of claim 21, wherein the audio/video data is captured from a program broadcasted by a cable television broadcast system, a wireless television broadcast system, or a network television broadcast system, and the audio/video data is a video clip, a photo, or a sound.

23. The method of claim 21, wherein the capture time information comprises time stamps related to capturing the audio/video data.

24. The method of claim 21, wherein the program information comprises at least one of a channel information, a program name information, a program participant information, a program type, and a metadata, or a combination thereof.

25. The method of claim 20, wherein each of the at least one user information comprises one of a user age, a user sex, a user place of residence, and a friend information based in the online social service, or a combination thereof.

26. The method of claim 20, wherein each of the at least one social behavior information comprises a usage condition of the related audio/video capture information on each of the at least one online social service, and the user information of users exploiting the related audio/video capture information on each of the at least one online social service.

27. The method of claim 26, wherein the usage condition comprises one of a share/link frequency, a view frequency, a comment frequency, and a comment content, or a combination thereof.

28. The method of claim 20, wherein the querying command comprises one of a time slot, a viewer age group, a viewer sex, and a program name, or a combination thereof, the at least one reference information is selected from the audience information database according to the querying command, and the step of generating the querying result of qualitative rating comprises:
selecting the at least one reference information from the audience information database matching the querying command, and generating the querying result of qualitative rating by statistically analyzing the at least one reference information.
